(19) United States
(12) Patent Application Publication
(10) Pub. No.: US 2019/0300017 A1
(43) Pub. Date: Oct. 3, 2019

(54) METHOD OF CONTROLLING A VEHICLE

(71) Applicant: GM Global Technology Operations LLC, Detroit, MI (US)

(72) Inventors: Daniel S. Glaser, West Bloomfield, MI (US); Yi G. Glaser, West Bloomfield, MI (US); Maureen A. Short, Grosse Point Woods, MI (US); Joseph F. Szczerba, Grand Blanc, MI (US)

(73) Assignee: GM Global Technology Operations LLC, Detroit, MI (US)

(21) Appl. No.: 15/943,059

(22) Filed: Apr. 2, 2018

(51) Int. Cl. B60W 50/14; G07C 5/00; G08G 1/0967

(52) U.S. Cl. CPC B60W 50/14; G07C 5/008; G08G 1/096791; B60W 50/16; B60W 2050/143; B60W 2050/146; G08G 1/096741

(57) ABSTRACT

A method of controlling a vehicle includes transmitting real time geographically tagged vehicle data from a transmitting vehicle to a database of a computing device. A caution area is identified based on the geographically tagged vehicle data from the at least one transmitting vehicle. A geographic boundary is defined surrounding the caution area. When the location of a receiving vehicle enters into the geographic boundary, a notification signal in the receiving vehicle is generated to alert an operator of the receiving vehicle to the caution area.

### INTRODUCTION

The disclosure generally relates to a method of controlling a vehicle.

Vehicle drivers often have to make quick decisions and act quickly when operating a vehicle. For example, when a driver encounters an object in the roadway, the driver must decide the safest course of action, and then control the vehicle to execute the desired course of action. The time between identifying the object and executing the desired course of action may be short. Additionally, some modern vehicles are now equipped with semi-autonomous operation, in which a vehicle controller controls the operation of the vehicle. However, in some situations, the vehicle controller is unable to decide how to control the vehicle, and signals the operator to manually control the vehicle. The time between the vehicle controller notifying the operator to manually control the vehicle and the operator having to determine a proper course of action and execute a driving maneuver may be short, causing stress to the driver.

### SUMMARY

A method of controlling a vehicle is provided. The method includes transmitting geographically tagged vehicle data from at least one transmitting vehicle to a database of a computing device in a remote location. A caution area is identified based on the geographically tagged vehicle data from the at least one transmitting vehicle, using a learning module of the computing device. A geographic boundary is defined surrounding the caution area, with the computing device. A location of a receiving vehicle is tracked. When the location of the receiving vehicle enters into the geographic boundary, a notification signal in the receiving vehicle is generated to alert an operator of the receiving vehicle to the caution area.

In one aspect of the method of controlling the vehicle, the geographically tagged vehicle data from the at least one transmitting vehicle is transmitted from the transmitting vehicle in real time, as the transmitting vehicle travels along a route.

In one embodiment of the method of controlling the vehicle, the geographically tagged vehicle data is transmitted from a plurality of transmitting vehicles.

In another aspect of the method of controlling the vehicle, the geographically tagged vehicle data from the at least one transmitting vehicle includes a real time geographic location of the transmitting vehicle, and data related to at least one of vehicle dynamics of the transmitting vehicle, a vehicle control system of the transmitting vehicle, or an operator initiated control input of the transmitting vehicle, occurring at the real time geographic location of the transmitting vehicle. The data related to the operator initiated control input of the transmitting vehicle may include, but is not limited to, data related to one of an accelerator input, a brake input, a steering input, a semi-autonomous vehicle deactivation input, a semi-autonomous vehicle activation input, or an eye gaze direction of an operator of the transmitting vehicle. The data related to the vehicle dynamics of the transmitting vehicle may include, but is not limited to, lateral acceleration data, longitudinal acceleration data, wheel slip data, wheel speed data, vertical acceleration data, engine speed data, or transmission speed data. The data related to the vehicle control system of the transmitting vehicle may include, but is not limited to, data related to one of a traction control system, a stability control system, a braking system, or a semi-autonomous driving system.

In one embodiment of the method of controlling the vehicle, the step of identifying the caution area based on the geographically tagged vehicle data from the transmitting vehicle includes identifying a pre-defined number of indicators located within a pre-defined distance of each other, from the geographically tagged vehicle data from the at least one transmitting vehicle. The geographically tagged vehicle data from the transmitting vehicle may be compared to a threshold to determine if the geographically tagged vehicle data from the transmitting vehicle is less than or equal to the threshold, or if the geographically tagged vehicle data from the transmitting vehicle is greater than the threshold. The geographically tagged vehicle data from the transmitting vehicle may be defined as an indicator when the geographically tagged vehicle data from the transmitting vehicle is greater than the threshold. When the learning module of the computing device detects a pre-defined number of indicators, within a pre-defined duration of time, all located within a pre-defined distance of one another, then the computing device may identify a caution area for the identified indicators.

In one embodiment of the method of controlling the vehicle, the computing device defines a center location of the caution area. The center location of the caution area may be defined as an average location of the indicators within the caution area. The geographic boundary surrounding the caution area may be defined based on a pre-defined distance from the center of the caution area. For example, the geographic boundary may be defined as a circular area having a radius equal to the pre-defined distance and a center located at the center of the caution area.

In another aspect of the method of controlling the vehicle, the computing device may delete the caution area when a number of indicators generated within the caution area and within a pre-defined duration of time decreases to below a pre-defined level. The notification signal is no longer generated after the caution area has been deleted.

In one embodiment of the method of controlling the vehicle, the computing device is located remotely from the receiving vehicle, and is disposed in communication with the receiving vehicle. In another embodiment of the method of controlling the vehicle, the computing device is integrated with the receiving vehicle.

In one aspect of the method of controlling the vehicle, the step of generating the notification signal may include, but is not limited to, displaying a text message, flashing a light, generating a sound, or generating a haptic signal. In one embodiment, the step of generating the notification includes increasing an intensity of the notification signal as the receiving vehicles nears the center of the caution area.

In one embodiment of the method of controlling the vehicle, the receiving vehicle is a semi-autonomous vehicle, and the step of generating the notification signal includes an indication of an impending likelihood that the operator of the receiving vehicle should assume manual operation of the receiving vehicle.

In one embodiment of the method of controlling the vehicle, the transmitting vehicle may capture an image of a road hazard, and include the captured image in the geographically tagged vehicle data transmitted from the transmitting vehicle. The computing device may analyze the captured image from the transmitting vehicle, and identify the hazard in the image. The notification signal to the receiving vehicle may include a message identifying the location and type of hazard identified in the captured image.

Accordingly, the method of controlling the vehicle described herein uses real time data from the transmitting vehicle to generate a notification signal in a receiving vehicle. The real time data from the transmitting vehicle may include data that is related to, but is not limited to, deactivation of a semi-autonomous driving system, a sudden braking maneuver, a sudden steering maneuver, an image of a hazard or obstacle, such as debris in a roadway or a pothole, etc. The receiving vehicle generates the notification signal when the receiving vehicle enters a caution area defined based on the real time data from the transmitting vehicle. The notification signal provides advanced warning to the operator of the receiving vehicle that increased vigilance may be required. For example, an exemplary notification signal for a semi-autonomous vehicle may include a message that the operator may soon be required to manually maneuver the receiving vehicle.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic plan view of a roadway representing a method of controlling a vehicle.

FIG. 2 is a flowchart representing the method of controlling the vehicle.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

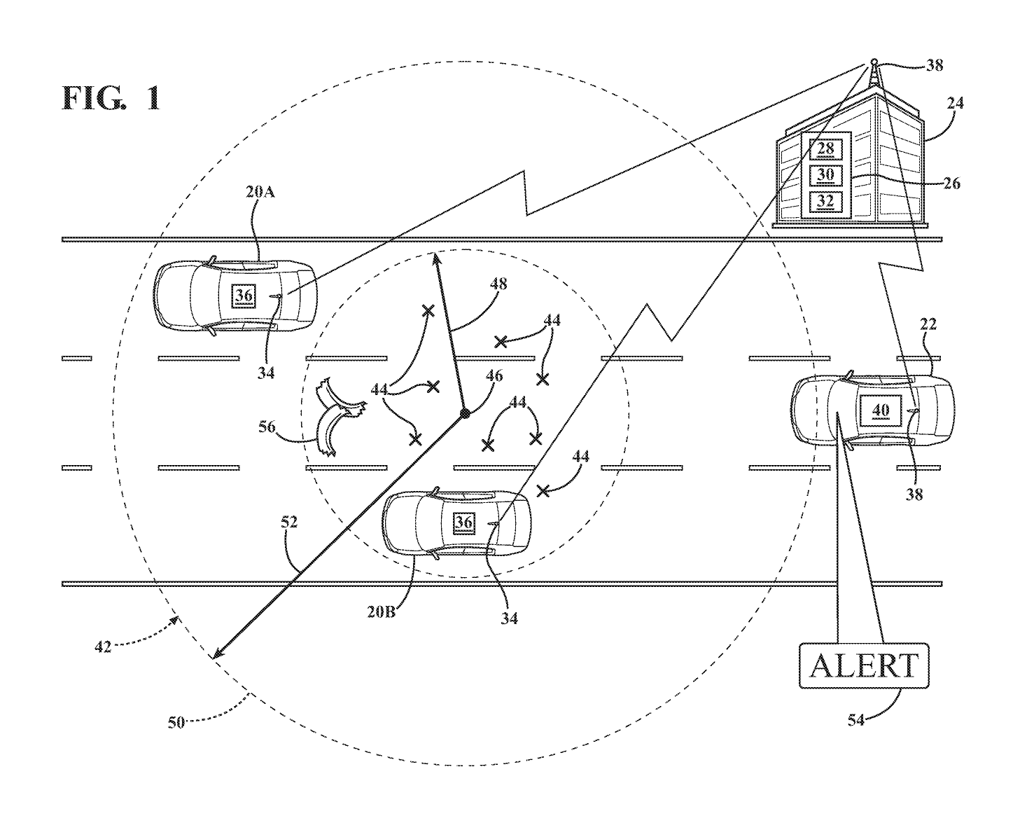

Referring to the FIGS., wherein like numerals indicate like parts throughout the several views, a method of controlling a vehicle is generally described herein. Referring to FIG. 1, the method uses real time vehicle data from one or more transmitting vehicles 20A, 20B, to control the operation of a receiving vehicle 22 in order to provide advance warning to a driver of the receiving vehicle 22. The real time data from the transmitting vehicles 20A, 20B is transmitted to a remote location 24. The remote location 24 is remotely located from and in communication with the transmitting vehicle. In the exemplary embodiment described herein and generally shown in FIG. 1, the remote location 24 is also remotely located from and in communication with the receiving vehicle 22. However, in other embodiments, the remote location 24 may be defined as the receiving vehicle 22. The remote location 24 houses a computing device 26 having memory 28, a database 32 saved on the memory 28, processor 30, hardware, software, etc., operable thereon. In embodiments where the remote location 24 is defined as the receiving vehicle 22, it should be appreciated that the receiving vehicle 22 houses the computing device 26 and associated memory 28, database 32, processor 30, hardware, software, etc.

Each of the transmitting vehicles 20A, 20B may include any vehicle that is capable of sensing, capturing, and transmitting data related to the operation of that specific transmitting vehicle. Vehicles may include different sensors for sensing operating characteristics of the vehicle in real time, and may include a transmitting device 34 to communicate with the remote location 24. Exemplary types of data are described below. The type of sensors used to sense the different types of data are understood by those skilled in the art, and are therefore not described in detail herein. Additionally, the type, style, and operation of the transmitting device 34 is not pertinent to the teachings of this disclosure, are understood by those skilled in the art, and are therefore not described in detail herein. Each of the transmitting vehicles 20A, 20B may include a respective vehicle controller 36 that is operable to control the operation of that respective transmitting vehicle, including the operation of any sensors of the transmitting vehicle, and operation of the transmitting device 34 of the transmitting vehicle.

The computing device 26 is located remotely from the transmitting vehicle. In the exemplary embodiment, the computing device 26 is also remotely located from the receiving vehicle 22. The computing device 26 may include a computer or other similar device that is operable to execute the steps of the method described herein. The computing device 26 may include a processor 30, and include all software, hardware, memory 28, algorithms, connections, sensors, etc., necessary to execute the process described herein. As such, the method of controlling the vehicle described herein may be embodied as a program or algorithm operable on the computing device 26.

The computing device 26 may be embodied as one or multiple digital computers or host machines each having one or more processors 30, read only memory 28 (ROM), random access memory 28 (RAM), electrically-programmable read only memory 28 (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory 28 may include any non-transitory/tangible medium which participates in providing data or computer-readable instructions. Memory 28 may be non-volatile or volatile. Non-volatile media may include, for example, optical or magnetic disks and other persistent memory 28. Example volatile media may include dynamic random access memory 28 (DRAM), which may constitute a main memory 28. Other examples of embodiments for memory 28 include a floppy, flexible disk, or hard disk, magnetic tape or other magnetic medium, a CD-ROM, DVD, and/or any other optical medium, as well as other possible memory 28 devices such as flash memory 28.

The computing device 26 includes tangible, non-transitory memory 28 on which are recorded computer-executable instructions. The processor 30 of the computing device 26 is configured for executing the instructions to perform the steps of the method described herein.

The receiving vehicle 22 includes a receiving device that is capable of receiving communications from the computing device 26 of the remote location 24. Additionally, the receiving vehicle 22 may further include a transmitting device 34 for transmitting communications with the remote location 24. In the exemplary embodiment, the receiving vehicle 22 includes a transmitter/receiver 38 for both transmitting and receiving electronic communications with the computing device 26 at the remote location 24. The receiving vehicle 22 may further include a vehicle controller 40 operable to control the operation of the vehicle, and generate a notification signal 54 described in greater detail below.

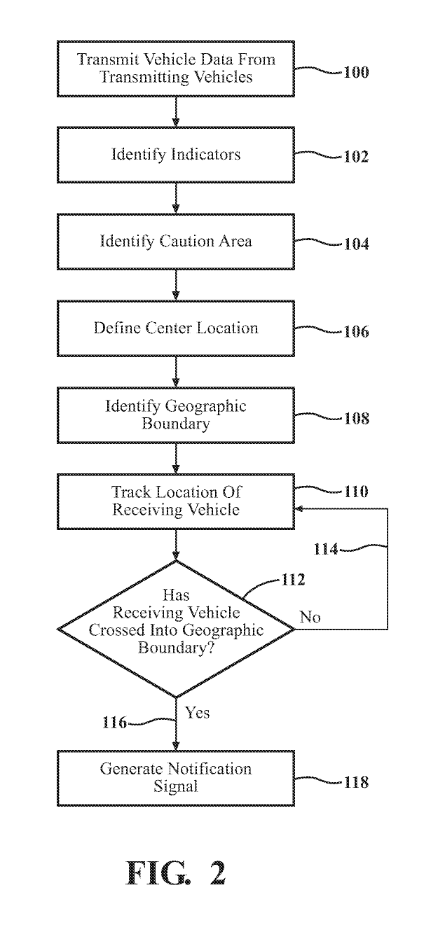

Referring to FIGS. 1 and 2, the process of controlling the receiving vehicle 22 includes transmitting geographically tagged vehicle data from at least one of the transmitting vehicles 20A, 20B. The step of transmitting the vehicle data from the transmitting vehicles 20A, 20B is generally represented by box 100 in FIG. 2. While the process may be used with only a single transmitting vehicle, it should be appreciated that better accuracy may be achieved from the vehicle data from multiple transmitting vehicles 20A, 20B. For example, Referring to FIG. 1, a first transmitting vehicle is generally shown at 20A, and a second transmitting vehicle is generally shown at 20B. Both the first transmitting vehicle 20A and the second transmitting vehicle 20B are in communication with and transmit respective vehicle data to the computing device 26 at the remote location 24. While only two transmitting vehicles 20A, 20B are shown, it should be appreciated that the process described herein may use vehicle data from any number of transmitting vehicles.

The geographically tagged vehicle data from the transmitting vehicles 20A, 20B is transmitted to and saved in the database 32 of the computing device 26 in the remote location 24. The vehicle data from the transmitting vehicles 20A, 20B is continuously transmitted in real time, as the transmitting vehicles 20A, 20B travel along a route. Accordingly, while the description generally describes a single communication of vehicle data, it should be appreciated that the transmitting vehicles 20A, 20B are transmitting a continuous stream of vehicle data to the database 32. The vehicle data from the transmitting vehicles 20A, 20B is tagged with the geographic location of the respective transmitting vehicle at the occurrence of the data event. Accordingly, the transmitted vehicle data includes a location, a time, and a data event.

The vehicle data transmitted from the transmitting vehicles 20A, 20B may include, but is not limited to, data, i.e., a data event, related to vehicle dynamics of the transmitting vehicle, a vehicle control system of the transmitting vehicle, or an operator initiated control input of the transmitting vehicle. The vehicle data transmitted from the transmitting vehicles 20A, 20B is vehicle operating data occurring at a given time, and at a geographic location of the respective transmitting vehicle. The vehicle data related to the operator initiated control input of the transmitting vehicle may include, but is not limited to, data related to one of an accelerator input, a brake input, a steering input, a semi-autonomous vehicle deactivation input, a semi-autonomous vehicle activation input, or an eye gaze direction of an operator of the transmitting vehicle. The vehicle data related to the vehicle dynamics of the transmitting vehicle may include, but is not limited to, lateral acceleration data, longitudinal acceleration data, wheel slip data, wheel speed data, vertical acceleration data, engine speed data, or transmission speed data. The vehicle data related to one or more vehicle control systems of the transmitting vehicle may include, but is not limited to, data related to one of a traction control system, a stability control system, a braking system, or a semi-autonomous driving system. In one exemplary embodiment, the geographically tagged vehicle data from the transmitting vehicle may include an image captured from a camera on the transmitting vehicle.

The computing device 26 uses the geographically tagged vehicle data from the transmitting vehicles 20A, 20B to identify a caution area 42. The computing device 26 may use a learning module to analyze the vehicle data from the transmitting vehicles 20A, 20B in order to identify the caution area 42. Notably, the vehicle data from the transmitting vehicles 20A, 20B may not directly identify a specific hazard or obstacle in the roadway. Rather, the computing device 26 analyzes the vehicle data from the transmitting vehicles 20A, 20B to identify occurrences that may be indicative of a situation that may require heightened operator awareness. The specific reason for the heightened operator awareness need not be known or derived by the computing device 26. The computing device 26 analyzes the vehicle data from the transmitting vehicles 20A, 20B to identify vehicle operations that are not normal, are very aggressive maneuvers, or in some manner indicate a non-standard driving condition that may require heightened awareness by the operator of the receiving vehicle 22. These occurrences may be referred to as indicators 44. For example, the computing device 26 may analyze the vehicle data to identify an aggressive braking event, a sudden lane change, or a sudden vertical acceleration. In other embodiments, in which the transmitting vehicles 20A, 20B includes a semi-autonomous driving system that automatically operates the vehicle with no or limited operator input, the computing device 26 may analyze the vehicle data from the transmitting vehicles 20A, 20B to determine if the semi-autonomous driving system reverted to manual operator control. FIG. 1 shows several indicators 44 generally clustered together.

The computing device 26 may identify the caution area 42 from the vehicle data of the transmitting vehicles 20A, 20B in a suitable manner. While it is contemplated that a single indicator 44 may be used to identify the caution area 42, in the exemplary embodiment, it is contemplated that the computing device 26 may analyze the vehicle data from multiple transmitting vehicles 20A, 20B to identify a pre-defined number of indicators 44 located within a pre-defined distance 48 of each other, and occurring within a pre-defined duration of time, in order to identify the caution area 42. As such, the computing device 26 must identify the indicators 44 from the vehicle data from the transmitting vehicles 20A, 20B. The step of identifying indicators is generally represented by box 102 in FIG. 2. The computing device 26 may identify indicators 44 in a suitable manner. For example, the computing device 26 may compare the geographically tagged vehicle data from the transmitting vehicles 20A, 20B to a threshold to determine if the geographically tagged vehicle data from the transmitting vehicles 20A, 20B is less than or equal to the threshold, or if the geographically tagged vehicle data from the transmitting vehicles 20A, 20B is greater than the threshold. The threshold may include a specific value or range for the particular type of vehicle data. The computing device 26 may define the vehicle data as an indicator 44 when the geographically tagged vehicle data from the transmitting vehicles 20A, 20B is greater than the threshold. For example, if the computing device 26 is analyzing vehicle data related to deceleration, then the threshold may include a maximum deceleration rate. If the deceleration rate indicated by the vehicle data is less than the threshold, i.e., less than the maximum deceleration rate, then the vehicle data may not be considered an indicator 44. However, if the deceleration rate indicated by the vehicle data is greater than the threshold, i.e., greater than the maximum deceleration rate, then the computing device 26 may identify that vehicle data as an indicator 44.

In another example, the vehicle data may include data related to some other vehicle operation. For example, if the vehicle is a semi-autonomous vehicle, then the vehicle data may be related to the activation or deactivation of the semi-autonomous driving system, and the threshold may be defined as a vehicle controller 36 initiated deactivation of the semi-autonomous driving system. As such, if the vehicle data indicates that the vehicle controller 36 of the respective transmitting vehicle initiated a deactivation of the semi-autonomous driving system, then the computing device 26 may define the vehicle data as an indicator 44. It should be appreciated that the vehicle data may include any data that may potentially indicate a need for the operator of the receiving vehicle 22 to exercise heightened awareness. Furthermore, it should be appreciated that the threshold for each type of vehicle data may differ. When the computing device 26 identifies more than the pre-defined number of indicators 44 located within the pre-defined distance 48 of each other, and which occur within the pre-defined duration of time, then the computing device 26 may identify that location as a caution area 42. The step of identifying the caution area 42 is generally represented by box 104 in FIG. 2.

The computing device 26 defines a center location 46 for the caution area 42. The step of defining the center location 46 is generally represented by box 106 in FIG. 2. The computing device 26 may define or determine the center location 46 for the caution area 42 in a suitable manner. Because the computing device 26 uses the vehicle data from the transmitting vehicles 20A, 20B to identify the caution area 42, the computing device 26 may not be able to specifically identify an exact cause or reason for the caution area 42, and may further not be able to identify an exact location of the cause for the caution area 42. However, since the caution area 42 was defined based on a number of indicators 44 occurring within the pre-defined distance 48 of each other, the computing device 26 may define the center location 46 for the caution area 42 based on an average geographic location of the indicators 44 identified within the caution area 42.

Once the computing device 26 has defined the center location 46 of the caution area 42, the computing device 26 may then define a geographic boundary 50 surrounding the caution area 42. The step of defining the geographic boundary 50 is generally represented by box 108 in FIG. 2. The geographic boundary 50 of the caution area 42 may be defined in any suitable manner, and may depend upon different factors, such as the type of roadway, speed of the vehicles, current driving conditions (snowy roads or dry roads), etc. For example, in the exemplary embodiment, the computing device 26 may define the geographic boundary 50 for the caution area 42 based on a pre-defined radial distance 52 from the center of the caution area 42. As such, the geographic boundary 50 would include a circular area having a radius equal to the pre-defined radial distance 52, and a center at the center location 46 of the caution area 42.

The process includes tracking a location of the receiving vehicle 22. The step of tracking the location of the receiving vehicle 22 is generally represented by box 110 in FIG. 2. The location of the receiving vehicle 22 may be tracked in a suitable manner. For example, the receiving vehicle 22 may be equipped with GPS, which may be used by the vehicle controller 40 to track the position of the receiving vehicle 22. There are many different ways and systems that may be used to track the location of the receiving vehicle 22 understood by those skilled in the art. The specific manner and equipment used to track the location of the receiving vehicle 22 is not pertinent to the teachings of this disclosure, and are therefore not described in detail herein.

The location of the receiving vehicle 22 and/or the geographic boundary 50 of the caution area 42 are communicated between the receiving vehicle 22 and the computing device 26 at the remote location 24. For example, in the exemplary embodiment described herein, the computing device 26 at the remote location 24 may transmit the geographic boundary 50 of the caution area 42 to the receiving vehicle 22, so that the receiving vehicle 22 may compare the current location of the receiving vehicle 22 to the geographic boundary 50 of the caution area 42. In another embodiment, the receiving vehicle 22 may transmit the current location of the receiving vehicle 22 to the computing device 26 at the remote location 24, so that the computing device 26 may compare the current location of the receiving vehicle 22 to the geographic boundary 50 of the caution area 42.

In the exemplary embodiment described herein, the computing device 26 at the remote location 24 transmits the geographic boundary 50 of the caution area 42 to the receiving vehicle 22. The vehicle controller 40 of the receiving vehicle 22 may then compare the current location of the receiving vehicle 22 to the geographic boundary 50 of the caution area 42. The step of comparing the location of the receiving vehicle 22 to the geographic boundary 50 is generally represented by box 112 in FIG. 2. If the receiving vehicle 22 has not yet crossed into the geographic boundary 50, generally indicated at 114, then the process continues to track the location of the receiving vehicle 22. When the location of the receiving vehicle 22 enters into the geographic boundary 50 of the caution area 42, generally indicated at 116, then the vehicle controller 40 of the receiving vehicle 22 generates a notification signal 54 in the receiving vehicle 22 to alert an operator of the receiving vehicle 22 to the caution area 42. The step of generating the notification signal 54 is generally represented by box 118 in FIG. 2.

In an alternative embodiment, in which the receiving vehicle 22 transmits the location of the receiving vehicle 22 to the computing device 26 at the remote location 24, the computing device 26 may then compare the current location of the receiving vehicle 22 to the geographic boundary 50 of the caution area 42. When the location of the receiving vehicle 22 enters into the geographic boundary 50 of the caution area 42, the computing device 26 transmits a signal to the receiving vehicle 22 causing the vehicle controller 40 of the receiving vehicle 22 to generate the notification signal 54 in the receiving vehicle 22 to alert the operator of the receiving vehicle 22 to the caution area 42.

The vehicle controller 40 of the receiving vehicle 22 may generate the notification signal 54 in a suitable manner. For example, the notification signal 54 may be generated by, but is not limited to, displaying a text message, flashing a light, generating a sound, generating a haptic signal, or by some other process intended to notify the operator of the receiving vehicle 22. In one exemplary embodiment, an intensity of the notification signal 54 is increased as the current location of the receiving vehicle 22 nears the center location 46 of the caution area 42.

In one exemplary embodiment, in which the receiving vehicle 22 is equipped with a semi-autonomous driving system that is operable to drive the receiving vehicle 22 without operator input under most operating conditions, then the notification signal 54 may include an indication of an impending likelihood that the operator of the receiving vehicle 22 should assume manual operation of the receiving vehicle 22, or that the semi-autonomous driving system may initiate a deactivation. Accordingly, by providing the operator of the receiving vehicle 22 the notification signal 54 as soon as the receiving vehicle 22 enters the geographic boundary 50 of the caution area 42, the operator may be alerted to the possibility that the semi-autonomous driving system of the receiving vehicle 22 may initiate a deactivation, which requires that the operator exercise manual control and operation of the receiving vehicle 22. The added warning provides the operator of the semi-autonomous vehicle with added time to prepare for manual operation of the receiving vehicle 22.

As noted above, the vehicle data from the transmitting vehicles 20A, 20B may include an image captured from one of the transmitting vehicles 20A, 20B. The computing device 26 may use image recognition software to identify an obstruction 56 in the image, and include the identification of the obstruction 56 in the notification signal 54. For example, if one of the transmitting vehicles 20A, 20B captures an image that shows debris in the center of a particular travel lane of a roadway, the computing device 26 may use the image recognition software to identify the object as an obstruction 56, include information in the notification signal 54 indicating the existence of the obstruction 56 in that particular travel lane of the roadway. In another example, the image recognition software may identify a pothole, ice covered roadway, etc. in the roadway, and include information in the notification signal 54 indicating the existence of the pothole, ice covered roadway, etc., in the particular travel lane of the road

Once the reason causing the indicators 44 has been removed or resolved, it is contemplated that the occurrence of future indicators 44 in that caution area 42 will diminish to zero or near zero over a duration of time. Accordingly, the computing device 26 may delete or deactivate the caution area 42 when the number of indicators 44 generated within the caution area 42 and within the pre-defined duration of time decreases to below the pre-defined number of occurrences. Once the caution area 42 has been deleted, the corresponding geographic boundary 50 of the caution area 42 is also deleted, and the process is ended.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A method of controlling a vehicle, the method comprising:
transmitting geographically tagged vehicle data from at least one transmitting vehicle to a database of a computing device in a remote location;
identifying a caution area based on the geographically tagged vehicle data from the at least one transmitting vehicle using a learning module of the computing device;
defining a geographic boundary surrounding the caution area with the computing device
tracking a location of a receiving vehicle; and
generating a notification signal in the receiving vehicle when the location of the receiving vehicle enters into the geographic boundary to alert an operator of the receiving vehicle to the caution area.

2. The method set forth in claim 1, wherein transmitting the geographically tagged vehicle data from the at least one transmitting vehicle is further defined as transmitting the geographically tagged vehicle data from the at least one transmitting vehicle in real time as the transmitting vehicle travels along a route.

3. The method set forth in claim 1, wherein transmitting the geographically tagged vehicle data from the at least one transmitting vehicle includes transmitting a real time geographic location of the transmitting vehicle and data related to at least one of vehicle dynamics of the transmitting vehicle, a vehicle control system of the transmitting vehicle, or an operator initiated control input of the transmitting vehicle, occurring at the real time geographic location of the transmitting vehicle.

4. The method set forth in claim 3, wherein the data related to the operator initiated control input of the transmitting vehicle includes data related to one of an accelerator input, a brake input, a steering input, a semi-autonomous vehicle deactivation input, a semi-autonomous vehicle activation input, or an eye gaze direction of an operator of the transmitting vehicle.

5. The method set forth in claim 3, wherein the data related to the vehicle dynamics of the transmitting vehicle includes lateral acceleration data, longitudinal acceleration data, wheel slip data, wheel speed data, vertical acceleration data, engine speed data, or transmission speed data.

6. The method set forth in claim 3, wherein the data related to vehicle control system of the transmitting vehicle includes data related to one of a traction control system, a stability control system, a braking system, or a semi-autonomous driving system.

7. The method set forth in claim 1, wherein transmitting the geographically tagged vehicle data from the at least one transmitting vehicle includes transmitting geographically tagged vehicle data from a plurality of transmitting vehicles.

8. The method set forth in claim 1, wherein identifying the caution area based on the geographically tagged vehicle data from the at least one transmitting vehicle includes identifying a pre-defined number of indicators located within a pre-defined distance of each other from the geographically tagged vehicle data from the at least one transmitting vehicle.

9. The method set forth in claim 8, wherein identifying the caution area based on the geographically tagged vehicle data from the at least one transmitting vehicle includes comparing the geographically tagged vehicle data from the at least one transmitting vehicle to a threshold to determine if the geographically tagged vehicle data from the at least one transmitting vehicle is less than or equal to the threshold, or if the geographically tagged vehicle data from the at least one transmitting vehicle is greater than the threshold.

10. The method set forth in claim 9, wherein identifying the caution area based on the geographically tagged vehicle data from the at least one transmitting vehicle includes defining the geographically tagged vehicle data from the at least one transmitting vehicle as a indicator when the geographically tagged vehicle data from the at least one transmitting vehicle is greater than the threshold.

11. The method set forth in claim 8, further comprising defining a center location of the caution area as an average location of the indicators within the caution area.

12. The method set forth in claim 11, wherein defining the geographic boundary surrounding the caution area includes defining the geographic boundary based on a pre-defined distance from the center of the caution area.

13. The method set forth in claim 8, further comprising deleting the caution area when a number of indicators generated within the caution area and within a pre-defined duration of time decreases to below a pre-defined level.

14. The method set forth in claim 1, wherein generating a notification signal includes increasing an intensity of the notification signal as the receiving vehicles nears a center of the caution area.

15. The method set forth in claim 1, wherein the receiving vehicle is a semi-autonomous vehicle, and wherein generating the notification signal includes an indication of an impending likelihood that the operator of the receiving vehicle should assume manual operation of the receiving vehicle.

16. The method set forth in claim 1, wherein transmitting the geographically tagged vehicle data from the at least one transmitting vehicle includes transmitting an image captured from a camera on the transmitting vehicle.

17. The method set forth in claim 16, further comprising identifying an obstruction in the image, and including the identification of the obstruction in the notification signal.

18. A method of controlling a vehicle, the method comprising:
transmitting geographically tagged vehicle data from at least one transmitting vehicle, in real time as the transmitting vehicle travels along a route, to a database of a computing device in a remote location, wherein the geographically tagged vehicle data from the at least one transmitting vehicle includes a real time geographic location of the transmitting vehicle and data related to at least one of vehicle dynamics of the transmitting vehicle, a vehicle control system of the transmitting vehicle, or an operator initiated control input of the transmitting vehicle, occurring at the real time geographic location of the transmitting vehicle;
identifying a pre-defined number of indicators located within a pre-defined distance of each other from the geographically tagged vehicle data from the at least one transmitting vehicle;
identifying a caution area based on the identified pre-defined number of indicators using a learning module of the computing device;
defining a geographic boundary surrounding the caution area with the computing device
tracking a location of a receiving vehicle; and
generating a notification signal in the receiving vehicle when the location of the receiving vehicle enters into the geographic boundary to alert an operator of the receiving vehicle to the caution area.

19. The method set forth in claim 18, wherein the receiving vehicle is a semi-autonomous vehicle, and wherein generating the notification signal includes an indication of an impending likelihood that the operator of the receiving vehicle should assume manual operation of the receiving vehicle.

20. A system comprising:
a transmitting vehicle operable to transmit geographically tagged vehicle data in real time as the transmitting vehicle travels along a route, wherein the geographically tagged vehicle data from the transmitting vehicle includes a real time geographic location of the transmitting vehicle and data related to at least one of vehicle dynamics of the transmitting vehicle, a vehicle control system of the transmitting vehicle, or an operator initiated control input of the transmitting vehicle, occurring at the real time geographic location of the transmitting vehicle;
a remote location having a computing device including a database, a processor, and a memory having an algorithm stored thereon, wherein the computing device is operable to receive the geographically tagged vehicle data from the transmitting vehicle, and transmit signals to a receiving vehicle;
wherein the receiving vehicle is operable to transmit signals to the computing device, and receive signals from the computing device at the remote location;
wherein the processor of the computing device is operable to execute the algorithm to:
identify a caution area based on the geographically tagged vehicle data from the transmitting vehicle using a learning module of the computing device;
define a geographic boundary surrounding the caution area with the computing device;
track a location of the receiving vehicle; and
transmit a notification signal to the receiving vehicle when the location of the receiving vehicle enters into the geographic boundary to alert an operator of the receiving vehicle to the caution area.
